(19) United States
(12) Patent Application Publication
(10) Pub. No.: US 2013/0043746 A1
(43) Pub. Date: Feb. 21, 2013

(54) BASE ASSEMBLY FOR MOTOR AND MOTOR INCLUDING THE SAME

(71) Applicant: Sang Jae Song, Suwon (KR)

(72) Inventor: Sang Jae Song, Suwon (KR)

(73) Assignee: Samsung Electro-Mechanics Co., Ltd, Suwon (KR)

(21) Appl. No.: 13/545,285

(22) Filed: Jul. 10, 2012

(30) Foreign Application Priority Data
Aug. 16, 2011 (KR) 10-2011-0081111

(51) Int. Cl. H02K 5/24

(52) U.S. Cl. 310/51

(57) ABSTRACT

There is provided a base assembly for a motor, the base assembly including: a base for a motor; and a pulling plate coupled to the base to prevent excessive floating of a rotating member of the motor, wherein the pulling plate includes a space part formed by extracting a predetermined region of the pulling plate so as to reduce noise generated during rotation of the rotating member.

### CROSS-REFERENCE TO RELATED APPLICATIONS

This application claims the priority of Korean Patent Application No. 10-2011-0081111 filed on Aug. 16, 2011, in the Korean Intellectual Property Office, the disclosure of which is incorporated herein by reference.

### BACKGROUND OF THE INVENTION

1. Field of the Invention

The present invention relates to a base assembly for a motor and a motor including the same, and more particularly, to a base assembly for a motor capable of reducing noise during rotation of a rotating member, and a motor including the same.

2. Description of the Related Art

A hard disk drive (HDD), an information storage device, reads data stored on a disk or writes data to a disk using a read/write head.

The hard disk drive requires a disk drive device capable of driving the disk. As the disk drive device, a small-sized motor is used.

A disk is mounted on the small-sized motor rotated such that data stored thereon can be read.

Here, the motor rotating the disk, a device converting electrical energy into mechanical energy, basically generates driving force for rotating the disk through electromagnetic interaction between a magnet and a coil.

Here, the coil is wound around teeth parts of a core, and the teeth parts are spaced apart from each other in order to allow the coil to be wound therearound, such that an outer side of one teeth part and an outer side of the other teeth part have an interval formed therebetween.

Therefore, in the case in which a magnet rotates outwardly of the core, cogging torque is generated due to the interval formed therebetween.

That is, attractive force between the magnet and the core is changed due to the rotation of the magnet, such that noise is generated due to the cogging torque.

The noise generated due to the cogging torque is an important factor that determines motor performance. Therefore, research into a technology capable of significantly reducing noise during rotation of a motor has been urgently demanded.

### SUMMARY OF THE INVENTION

An aspect of the present invention provides a base assembly for a motor capable of significantly reducing noise due to cogging torque during rotation of a rotating member, and a motor including the same.

According to an aspect of the present invention, there is provided a base assembly for a motor, the base assembly including: a base for a motor; and a pulling plate coupled to the base to prevent excessive floating of a rotating member of the motor, wherein the pulling plate includes a space part formed by extracting a predetermined region of the pulling plate so as to reduce noise generated during rotation of the rotating member.

The pulling plate may be formed to have an arc shape while corresponding to a magnet provided in the rotating member.

An interval between extracted surfaces of the pulling plate defining the space part may increase in an outer radial direction.

An extracted angle e between extracted surfaces of the pulling plate defining the space part, based on a center of rotation of the rotating member, may satisfy the following Conditional Equation:

$$Extracted Angle ( θ ) \leq \frac{360 °}{N}$$

where N indicates the number of magnetized poles of a magnet provided in the rotating member.

The pulling plate may have a facing part disposed to face a lower surface of a magnet provided in the rotating member and an extension part bent from an end portion of the facing part.

According to another aspect of the present invention, there is provided a motor including: the base assembly as described above; a sleeve coupled to the base and supporting rotation of a shaft and a hub that configure the rotating member; and a core coupled to the base and having a coil wound therearound, the coil generating rotational driving force.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a base assembly for a motor according to an embodiment of the present invention and an enlarged schematic perspective view showing a core and a pulling plate;

FIG. 2 is a schematic perspective view showing the base assembly for a motor according to the embodiment of the present invention;

FIG. 3 is an enlarged schematic plan view of part A of FIG. 2; and

FIG. 4 is a graph showing measurement results of noise degree for each frequency band of the motor (the number of magnetized poles of a magnet: 12) according to the embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and that those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, like reference numerals will be used to designate like components having similar functions throughout the drawings within the scope of the present invention.

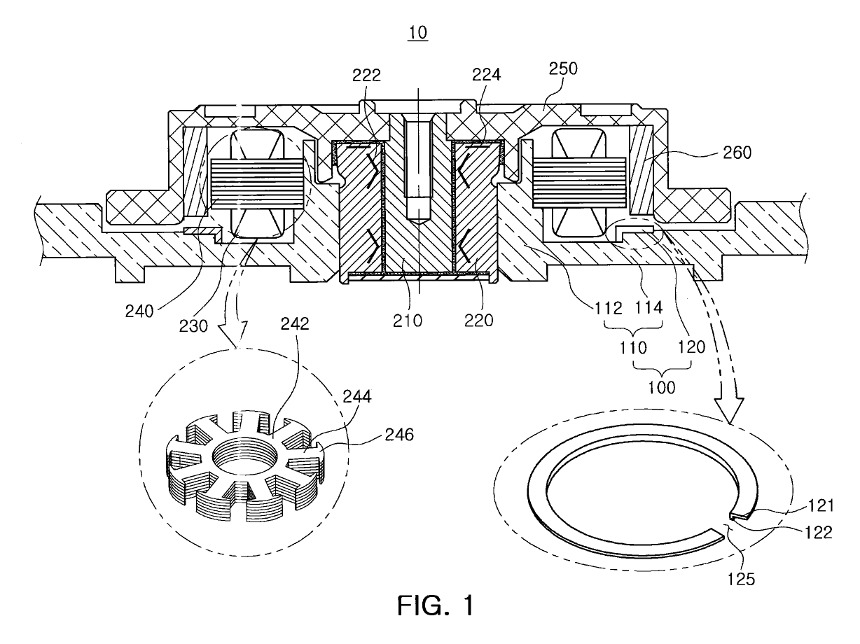

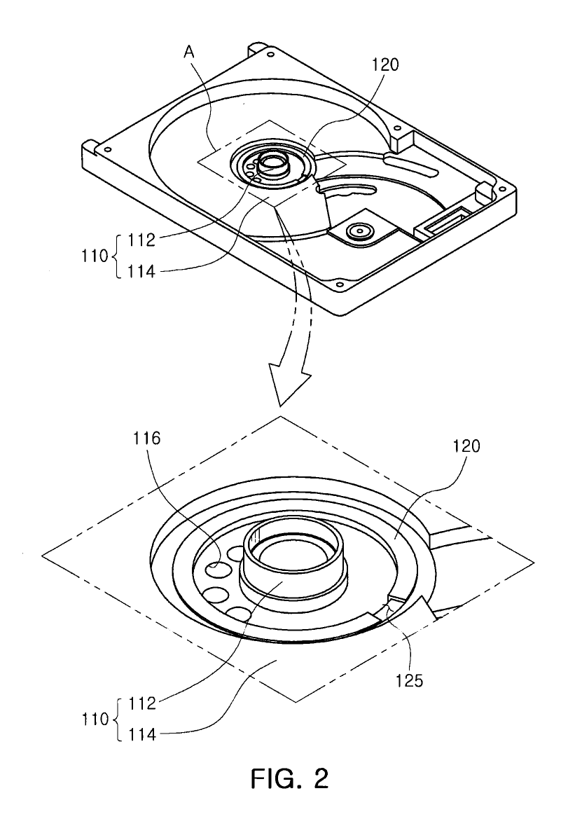

FIG. 1 is a schematic cross-sectional view showing a motor including a base assembly for a motor according to an embodiment of the present invention and an enlarged schematic perspective view showing a core and a pulling plate; and FIG. 2 is a schematic perspective view showing the base assembly for a motor according to the embodiment of the present invention.

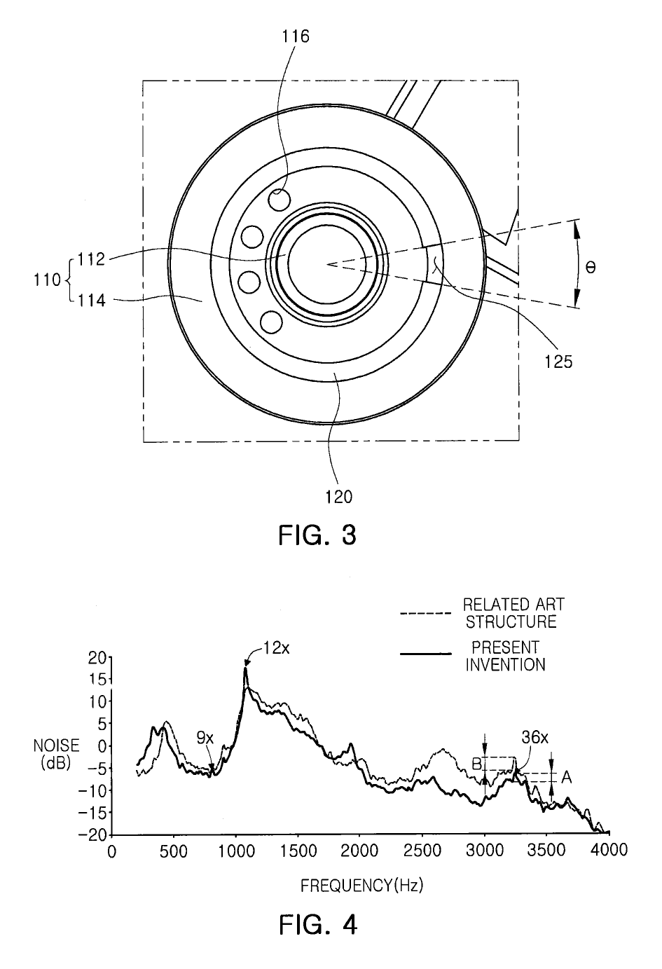

FIG. 3 is a enlarged schematic plan view of part A of FIG. 2; and FIG. 4 is a graph showing measurement results of noise degree for each frequency band of the motor (the number of magnetized poles of a magnet: 12) according to the embodiment of the present invention.

Referring to FIGS. 1 through 4, a motor 10 including a base assembly 100 (hereinafter, referred to as a base assembly) for a motor according to an embodiment of the present invention may include the base assembly 100 including a base 110 (hereinafter, referred to as a base) for a motor, a sleeve 220 supporting rotation of a rotating member, and a core 240 having a coil 230 wound therearound.

Terms with respect to directions will be first defined. As viewed in FIG. 1, an axial direction refers to a vertical direction based on a shaft 210, and an outer radial direction or an inner radial direction refers to a direction towards an outer edge of a hub 250 based on the shaft 210 or a direction towards the center of the shaft 210 based on the outer edge of the hub 250.

In addition, a circumferential direction refers to a rotation direction of the shaft 210, that is, a rotation direction along an outer peripheral surface of the shaft 210.

The base assembly 100 may include the base 110 and a pulling place 120 having a space part 125. The base 110 may have the core 240 coupled thereto and the core 240 may have the coil 230 wound therearound.

In other words, the base 110 may be a fixed member supporting a rotating member including the hub 250, and the base 110 may be coupled to the coil 230 generating electromagnetic force having a predetermined magnitude at the time of application of power and the core 240 having the coil 230 wound therearound.

Here, the base 110 may include a protrusion part 112 and a body part 114. An inner peripheral surface of the protrusion part 112 may be coupled to an outer peripheral surface of the sleeve 220 supporting the shaft 210, to thereby support the sleeve 220.

That is, the protrusion part 112 may have a central hole and be protruded in an upward axial direction, and the sleeve 220 supporting the shaft 210 may be inserted into the central hole and coupled thereto by a welding method, a bonding method, a press-fitting method, or the like.

In addition, an outer peripheral surface of the protrusion part 112 may be coupled to the core 240 having the coil 230 wound therearound. Rigidity of the core 240 needs to be secured in order to secure rotational stability of the motor 10 according to the embodiment of the present invention.

Further, the base 110 corresponding to the coil 230 may include coil lead holes 116 formed herein in order to allow lead wires of the coil 230 to be led to the outside of the base 110.

The lead wires of the coil 230 led to the outside while penetrating through the coil lead holes 116 may be electrically connected to a printed circuit board coupled to a lower surface of the base 110 so that external power may be supplied.

Here, the body part 114 of the base 110 may be coupled to the pulling plate 120, and the pulling plate 120 may prevent excessive floating of the rotating member including the shaft 210 and the hub 250.

More specifically, the pulling plate 120 may be coupled to the body part 114 corresponding to a lower surface of a magnet 260 coupled to the hub 250 in a coupling scheme such as a bonding scheme, or the like, and have magnetism so that attractive magnetic force acts between the pulling plate 120 and the magnet 260.

The shaft 210 and the hub 250, rotating members of the motor 10, according to the embodiment of the present invention, need to be floated at a predetermined height in order to rotate stably. However, in the case in which the shaft 210 and the hub 250 are floated above a pre-designed floating height, performance may be negatively affected.

In this case, in order to prevent the excessive floating of the shaft 210 and the hub 250, the rotating members, the pulling plate 120 may be coupled to the base 110. Therefore, excessive floating of the rotating members may be prevented by the attractive magnetic force acting between the pulling plate 120 and the magnet 260.

Here, the pulling plate 120 may have a facing part 121 disposed to face the lower surface of the magnet 260 provided in the rotating member and an extension part 122 bent from an end portion of the facing part 121.

In addition, the pulling plate 120 may be formed to have an arc shape in a circumferential direction while corresponding to the magnet 260 and include the space part 125 formed by extracting a predetermined region of the pulling plate 120.

The space part 125 may be provided for reducing noise generated during the rotation of the rotating member including the shaft 210 and the hub 250. An interval between extracted surfaces of the pulling plate 120 defining the space part 125 may increase in the outer radial direction.

In addition, an extracted angle e between the extracted surfaces defining the space part 125 may satisfy the following

Conditional Equation.

$$Extracted Angle ( θ ) \leq \frac{360 °}{N}$$

where N indicates the number of magnetized poles of the magnet provided in the rotating member.

The motor 10 according to the embodiment of the present invention may prevent electromagnetic noise due to cogging torque during the rotation of the rotating member by the space part 125 satisfying the above-mentioned Conditional Equation.

Here, in the case in which the extracted angle (θ) between the extracted surfaces defining the space part 125 does not satisfy the above-mentioned Conditional Equation, an effect in which a noise component corresponding to 36x Hz, to be described below, is reduced, as compared to the case in which the space part is not present, may be significantly lowered.

In addition, an effect in which a peak value of the noise corresponding to 36x Hz with respect to noise in a frequency band adjacent to 36x Hz is reduced, as compared to the related art structure in which the space part is not present, may also be significantly lowered.

A detailed description thereof will be provided with reference to FIG. 4. In the motor 10 according to the embodiment of the present invention, noise may be generated due to several factors during the rotation of the rotating member. When noise is classified for each frequency band (using a Fourier series), continuous noise may be generated in all frequency bands.

However, a noise determining performance of the motor 10 according to the embodiment of the present invention may focus on electromagnetic noise occurring due to cogging torque generated during the rotation of the rotating member including the shaft 210 and the hub 230, and the electromagnetic noise may be generated due to several factors. The most important factor among these factors may arise from the core 240, the magnet 260, or a combination of the core 240 and the magnet 260.

Hereinafter, electromagnetic noise (hereinafter, referred to as noise) occurring due to the cogging torque will be described in detail.

First, the core 240 may include a coreback 242 inserted into and coupled to the protrusion part 112 of the base 110, a plurality of teeth parts 244 protruded from the core back 242 in the outer radial direction and having the coil 230 substantially wound therearound, and front end parts 246 defining edges of the teeth parts 244 in the outer radial direction.

The front end parts 246 may be spaced apart from each other, which may be a requisite configuration for facilitating winding of the coil 230.

Generally, the number of teeth parts 244 of the core 240 may be nine. Therefore, the number of intervals between the front end parts 246 may be nine.

Accordingly, a change in attractive magnetic force acting between the magnet 260 and the core 240, that is, cogging torque, may be generated during the rotation of the hub 250 including the magnet, regardless of the number of magnetized poles of the magnet, and noise may be generated due to the cogging torque.

In other words, when the magnet, of which the number of magnetized poles is ignored, rotates around the core 240 including nine teeth parts 244 once, noise according to strength and weakness of the attractive magnetic force generated by the intervals between the front end parts 246 may be generated nine times.

Further, the motor 10 according to the embodiment of the present invention may have a speed of 5400 revolutions per minute (rpm), which means that there are 90 rotations per second. Therefore, when the motor 10 has a speed of 5400 rpm, a frequency becomes 90 Hz.

Therefore, an amount of noise generated every second when the magnet, of which the number of magnetized poles is ignored, rotates around the core 240 including the nine teeth parts 244 is 9*90, which means that a noise generation period is

$$\frac{1}{9 * 90}$$

sec.

Here, when the above-described noise is classified for each frequency band (using the Fourier series), a noise peak may become 9*90 Hz.

In other words, a noise peak may be generated at a frequency corresponding to 9× Hz (x indicates a frequency according to rotations of the motor 10 per second, according to the embodiment of the present invention) by the core 240 including the nine teeth parts 244.

However, since noise corresponding to 9x Hz has a magnitude significantly reduced by other factors in the case of manufacturing a hard disk drive including the motor 10, according to the embodiment of the present invention, it does not cause annoyance to a user, such that it is not significantly problematic.

Further, in the motor 10 according to the embodiment of the present invention, the noise peak may also generated in a frequency band of 12x Hz, associated with the number of magnetized poles of the magnet 260 coupled to the hub 250.

In other words, in the motor 10 according to the embodiment of the present invention, the number of magnetic poles of the magnet 260 may be twelve, and noise may be generated twelve times when the magnet 260 rotates around the core once, due to unbalance of magnetic pole intensity of the magnet 260 regardless of the core.

This noise may be caused by the strength and weakness of the attractive magnetic force between the magnet 260 and the core due to the unbalance of the magnetic pole intensity of the magnet 260. Noise generation number per second may be 12*90 when a structure of the core is ignored, which means that a noise generation period is

$$\frac{1}{12 * 90}$$

sec.

Here, when the above-described noise is classified for each frequency band (using the Fourier series), a noise peak may become 12*90 Hz.

In other words, a noise peak is generated at a frequency corresponding to 12x Hz (x indicates a frequency according to rotations per second of the motor 10, according to the embodiment of the present invention) by the magnet 260 magnetized to have twelve poles.

However, since noise corresponding to 12x Hz has a magnitude significantly reduced by other factors in the case of manufacturing a hard disk drive including the motor 10 according to the embodiment of the present invention, similar to the noise corresponding to 9x Hz, it does not cause annoyance to a user, such that it is not significantly problematic.

Finally, in the motor 10 according to the embodiment of the present invention, the electromagnetic noise due to the cogging torque may be generated by a combination of the core 240 and the magnet 260 during the rotation of the rotating member.

In other words, when the number of magnetic poles of the magnet 260 is twelve and the intervals between the front end parts 246 of the core 240 are nine, an amount of noise generated when the magnet 260 rotates around the core 240 once maybe determined by the lowest common multiple between 12 and 9.

That is, since the lowest common multiple between 12 and 9 is 36, the amount of noise incidents generated when the magnet 260 rotates around the core 240 once may be 36. Therefore, since the frequency of the motor 10 according to the embodiment of the present invention is 90 Hz, a noise generation period may be

$$\frac{1}{36 * 90}$$

sec.

Here, when the above-described noise is classified for each frequency band (using the Fourier series), a noise peak may become 36*90 Hz.

In other words, a noise peak may be generated at a frequency corresponding to 36x Hz (x indicates a frequency according to rotations per second of the motor 10 according to the embodiment of the present invention) by the core 240 including the nine teeth parts 244 and the magnet 260 magnetized to have twelve poles.

Here, the noise at 36x Hz may be prominent discrete tone (PDT) noise, which means a user may experience annoyance, since noise in a specific frequency band is more prominent than in an adjacent frequency band.

Therefore, in the motor 10 according to the embodiment of the present invention, the noise corresponding to 36x Hz among the above-mentioned 9x Hz, 12x Hz, and 36x Hz noises needs to be significantly reduced in order to reduce the noise during the rotation of the rotating member.

It could be appreciated from FIG. 4 that noise corresponding to 36x Hz was reduced in the motor 10 according to the embodiment of the present invention, as compared to the related art motor including a pulling plate continuously formed to correspond to the magnet in the circumferential direction, by the pulling plate 120 including the space part 125.

Further, since a peak value A of the noise corresponding to 36x Hz with respect to the noise in a frequency band adjacent to 36x Hz is reduced as compared to that B of the related art structure, a degree of noise sensed by the user may be further reduced.

Meanwhile, a noise peak value corresponding to 12x Hz has been increased. However, since this noise may not be annoying, due to factors according to a process of manufacturing a hard disk drive, it does not have an influence on overall noise.

In addition, magnitudes of the noise corresponding to 12x Hz and noise in a band lower than 36x Hz by a predetermined frequency do not have an influence on overall noise.

The above-mentioned effect may be generated by the space part 125 formed in the pulling plate 120, which means that an amount of magnetic flux directed from the magnet 260 toward the pulling plate 120 may be unbalanced by the space part 125 (Therefore, a peak value of the 12x noise increases).

Here, the reason for which the space part 125 is formed in the pulling plate 120 in order to make the amount of magnetic flux directed from the magnet 260 toward the pulling plate 120 unbalanced is that the space part 125 may easily adjust an amount of unbalance in the amount of magnetic flux.

In other words, since the amount of magnetic flux of the magnet 260 is relatively smaller in the lower surface of the magnet 260 than in a surface thereof facing the core 240, the space part 125 may prevent the generation of an excessive unbalance while easily adjusting the an amount of magnetic unbalance.

The shaft 210, coupled to the hub 250 to rotate together therewith, may be supported by the sleeve 220.

The sleeve 220, a component supporting rotation of the shaft 210 and the hub 250, may support the shaft 210 so that an upper end of the shaft 210 is protruded in the upward axial direction, and may be formed by forging Cu or Al or sintering a Cu—Fe based alloy powder or an SUS based power.

In addition, the sleeve 220 may include a shaft hole having the shaft 210 inserted thereinto so as to form a micro clearance therebetween, and the micro clearance is filled with oil O, such that the shaft 210 may be stably supported by radial dynamic pressure in the oil O.

Here, the radial dynamic pressure in the oil O may be generated by a fluid dynamic pressure part 222 formed as a groove in an inner peripheral surface of the sleeve 220. The fluid dynamic pressure part 222 may have one of a herringbone shape, a spiral shape, and a helix shape.

However, the fluid dynamic pressure part 222 is not limited to being formed in the inner peripheral surface of the sleeve 220 as described above but may also be formed in an outer peripheral surface of the shaft 210, the rotating member. In addition, the number of fluid dynamic pressure parts 222 is also not limited.

In addition, the sleeve 220 may include a thrust dynamic pressure part 224 formed in an upper surface thereof so as to generate thrust dynamic pressure in the oil O. The rotating member including the shaft 210 may rotate in a state in which a predetermined amount of floating force is secured by the thrust dynamic pressure part 224.

Here, the thrust dynamic pressure part 224 may be a groove having a herringbone shape, a spiral shape, or a helix shape, similar to the fluid dynamic pressure part 222. However, the thrust dynamic pressure part 224 is not necessarily limited to having the above-mentioned shape, but may have any shape, as long as thrust dynamic pressure may be provided thereby.

In addition, the thrust dynamic pressure part 224 is not limited to being formed in the upper surface of the sleeve 220, but may also be formed in one surface of the hub 250 corresponding to the upper surface of the sleeve 220.

Further, a base cover 270 may be coupled to a lower portion of the sleeve 220 so as to close the lower portion thereof. The motor 10 according to the embodiment of the present invention may be formed in a full-fill structure by the base cover 270.

The hub 250 maybe a rotating structure provided to be rotatable with respect to the fixed member including the base 110, and include the above-mentioned annular ring shaped magnet 260 corresponding to the core 240, having a predetermined interval therebetween.

Here, the magnet 260 interacts with the coil 230 wound around the core 240, whereby the motor 10 according to the embodiment of the present invention may obtain rotational driving force.

In the motor 10 according to the above-mentioned embodiments of the present invention, the space part 125 is formed in the pulling plate 120 preventing excessive floating of the rotating member, whereby the noise corresponding to 36x Hz causing annoyance to a user may be significantly reduced.

In addition, the peak value A of the noise corresponding to the 36x frequency band with respect to the noise corresponding to the frequency band adjacent to 36x is significantly reduced, whereby the intensity of the noise sensed by the user may be reduced.

As set forth above, in a base assembly and a motor including the same according to embodiments of the present invention, noise is reduced during the rotation of a rotating member, whereby performance and a lifespan of the motor may be improved.

In addition, a peak value of noise corresponding to a 36x frequency band with respect to noise corresponding to a frequency band adjacent to 36x is significantly reduced, whereby the intensity of noise sensed by a user may be reduced.

While the present invention has been shown and described in connection with the embodiments, it will be apparent to those skilled in the art that modifications and variations can be made without departing from the spirit and scope of the invention as defined by the appended claims.

What is claimed is:

1. A base assembly for a motor, the base assembly comprising:
a base for a motor; and
a pulling plate coupled to the base to prevent excessive floating of a rotating member of the motor,
wherein the pulling plate includes a space part formed by extracting a predetermined region of the pulling plate so as to reduce noise generated during rotation of the rotating member.

2. The base assembly of claim 1, wherein the pulling plate is formed to have an arc shape while corresponding to a magnet provided in the rotating member.

3. The base assembly of claim 1, wherein an interval between extracted surfaces of the pulling plate defining the space part increases in an outer radial direction.

4. The base assembly of claim 1, wherein an extracted angle θ between extracted surfaces of the pulling plate defining the space part, based on a center of rotation of the rotating member, satisfies the following Conditional Equation:
$$Extracted Angle ( θ ) \leq \frac{360 °}{N}$$
where N indicates the number of magnetized poles of a magnet provided in the rotating member.

5. The base assembly of claim 1, wherein the pulling plate has a facing part disposed to face a lower surface of a magnet provided in the rotating member and an extension part bent from an end portion of the facing part.

6. A motor comprising:
the base assembly of claim 1;
a sleeve coupled to the base and supporting rotation of a shaft and a hub that configure the rotating member; and
a core coupled to the base and having a coil wound therearound, the coil generating rotational driving force.
